(19) United States
(12) Patent Application Publication
(10) Pub. No.: US 2007/0143094 A1
(43) Pub. Date: Jun. 21, 2007

(54) Systems, methods, and media for integrating and driving experimental design and analysis

(76) Inventors: Robert J. Torres, Colleyville, TX (US); James Robert Rudd, Charlotte, NC (US)

Correspondence Address: IBM CORPORATION;INTELLECTUAL PROPERTY LAW, 11400 BURNET ROAD, AUSTIN, TX, 78758, US

(21) Appl. No.: 11/304,947

(22) Filed: Dec. 15, 2005

(51) Int. Cl. G06F 9/45

(52) U.S. Cl. 703/22

(57) ABSTRACT

Systems, methods and media for an integrated experimental planning, design, and analysis framework are disclosed for describing an experimental design in a data processing system. The framework includes a collection of structured experimental state inputs for organizing possible experimental information. A configurable table structure is simultaneously displayed along with the collection of structured experimental state inputs . A user is provided with the ability to cause automatic setup of the configurable table structure based on user's selection of one of a plurality of experimental techniques. The configurable table structure may be further modified using direct or drag and drop operations. Once the user has completed the modification of entries in the configurable table structure, selected processing of experiments are carried. Outputs from the executed experiments are stored and integrated into the configurable table structure. The user is allowed to interactively adjust and review the experimental input and output information in a post hoc manner from the table structure.

### FIELD OF INVENTION

The present invention is in the field of data processing systems and, in particular, to systems, methods and media for automating the design, execution and analysis of experimental designs in order to overcome functional, user interface, and usability deficiencies.

### BACKGROUND

The need to improve a process or a product is an ongoing effort in order to achieve peak performance and optimal product formulations. This is achieved by understanding potential sources of variation and critical parameters for achievement of performance characteristics and the determination of the optimum values to achieve both performance characteristics and minimize variations. An analyst/user must employ a structured, organized method for determining the relationship between factors affecting a process and the output of that process. This requires a highly skilled individual who must accurately specify the necessary experimental models and use the correct statistical analysis to achieve the desired outcome. The complexity of the process is illustrated in FIG. 1 which describes the steps that an analyst must manually perform to establish a simple experimental design. The analyst must first create simulation models of the real world as shown in block 10. This is followed by the creation of an experimental design to evaluate the model's representation of the real world as shown in block 12. The analyst must then translate the experimental design into the model's inputs as shown in block 14. This is followed at block 16 by inputting the translated design into the model for each step of the experimental design. At block 18, the model must be executed for each step of the experiment identified by the analyst. Once model execution is completed, the analyst must extract the simulation results for each step of the experiment as shown at block 20 and input the simulation results into an analysis tool as shown in block 21. Finally, the procedure requires tracking the execution of the experimental design for each step as shown at block 22. At block 24, a determination is made by the analyst whether the experiment has been successfully completed. If yes, the experiment is deemed to be completed and the procedure ends at block 26. However, if the analyst determines at block 24, that multiple iterations of the experimental steps require repeating, the procedure proceeds to block 16 to allow additional processing.

One product directed to providing an easy-to-use format for optimizing a product or process is the Design-Expert® Software produced by Northwest Analytical. The Design-Expert product allows an analyst to screen for vital factors, locate ideal process settings to achieve peak performance and to discover optimal product formulations. The product allows the analyst to build a design and generate worksheets with experiments laid out in a randomized run-order. The Design-Expert product also provides the analyst with multiple statistical options such as fractional factorials, Taguchi, orthogonal arrays, Placket-Burman, etc. The product allows an analyst to view output numerical data in spreadsheet style. While Design-Expert provides a host of automated features to an analyst, it accomplishes it via a static table that is used to generate a spreadsheet for run planning in an “off-line” manner. There is still a need for an easy-to-use technique for optimizing a product or process where the invention builds a table, lets a user interact with the table via drag and drop operations, and uses the table for tracking results in a real-time manner.

### SUMMARY OF THE INVENTION

It is therefore one objective of the present invention to provide a method for automating the design, execution, and analysis of experimental design based studies for data processing systems.

It is another objective of the present invention to provide an improved method of accurately specifying an experimental model by which experimental techniques are conducted.

It is yet another objective of the present invention to provide an easy-to-use, self-organizing, and guided model for optimizing products and processes using experimental design studies.

The foregoing objectives are achieved as follows. An integrated experimental planning, design, and analysis framework is disclosed for describing an experimental design in a data processing system. The framework includes a hierarchical structure having a collection of structured experimental state inputs which are shown in the embodiments as a tree structure for organizing possible experimental inputs. A configurable table structure is simultaneously displayed along with the tree structure. A user is provided with the ability to cause automatic setup of the configurable table structure based on the user's selection of one of a plurality of experimental techniques (e.g., Fractional Factorial, Taguchi, Ad Hoc, Latin Square, etc.).

The configurable table structure may be further modified using direct or drag and drop operations. Once the user has completed the modification of entries in the configurable table structure, selected processing of experiments are carried out based on user selections. Outputs from the executed experiments are stored and integrated into the configurable table structure. The user is allowed to interactively adjust and review the input and output information in a post hoc manner.

### BRIEF DESCRIPTION OF THE DRAWINGS

Other objects and advantages of the invention will become apparent upon reading the following detailed description and upon reference to the accompanying drawings in which, like references may indicate similar elements:

FIG. 1 depicts the manual steps required by an analyst to model a simple experimental design;

FIG. 2 depicts a pictorial representation of a network of data processing systems in which exemplary aspects of the present invention may be implemented;

FIG. 3 depicts a block diagram of a data processing system in which exemplary aspects of the present invention may be implemented;

FIG. 4 depicts a block diagram of a typical software architecture for a server-client system in which exemplary aspects of the present invention may be implemented;

FIG. 5 depicts a block diagram of the experimental design tool of the invention according to one embodiment;

FIG. 6 depicts a graphical view of a Run Planner input screen illustrating a table with input fields available to an analyst according to one embodiment of the invention;

FIG. 7 depicts a graphical view of a Run Planner input screen for user selection of an experimental technique;

FIG. 8 depicts a flow diagram for selection of Run Planner's input screens, experimental techniques or variable selections according to the present invention;

FIG. 9 depicts a graphical view of a Run Planner input screen for stipulation of variable, level and replication selections;

FIG. 10 depicts a flow diagram for creation of level, replication and variable templates according to one embodiment of the invention;

FIG. 11 depicts a graphical view of a Run Planner input screen showing drag-and-drop updates of fields;

FIG. 12 depicts a graphical view of a Run Planner input screen with drag-and-drop updates of fields for experimental conditions in a table according to the present invention;

FIG. 13 depicts a flow diagram for updating a table using drag-and-drop operations according to the present invention;

FIG. 14 depicts a graphical view of a Run Planner input screen with updated table entries displaying the status and results of experiments according to the present invention; and

FIG. 15 depicts a graphical view of a Run Planner screen for Post-Hoc interactive analysis of experiments according to the present invention.

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments; on the contrary, the intention is to cover all modifications, equivalents, and alternatives falling within the spirit and scope of the present invention as defined by the appended claims. The descriptions below are designed to make such embodiments obvious to a person of ordinary skill in the art.

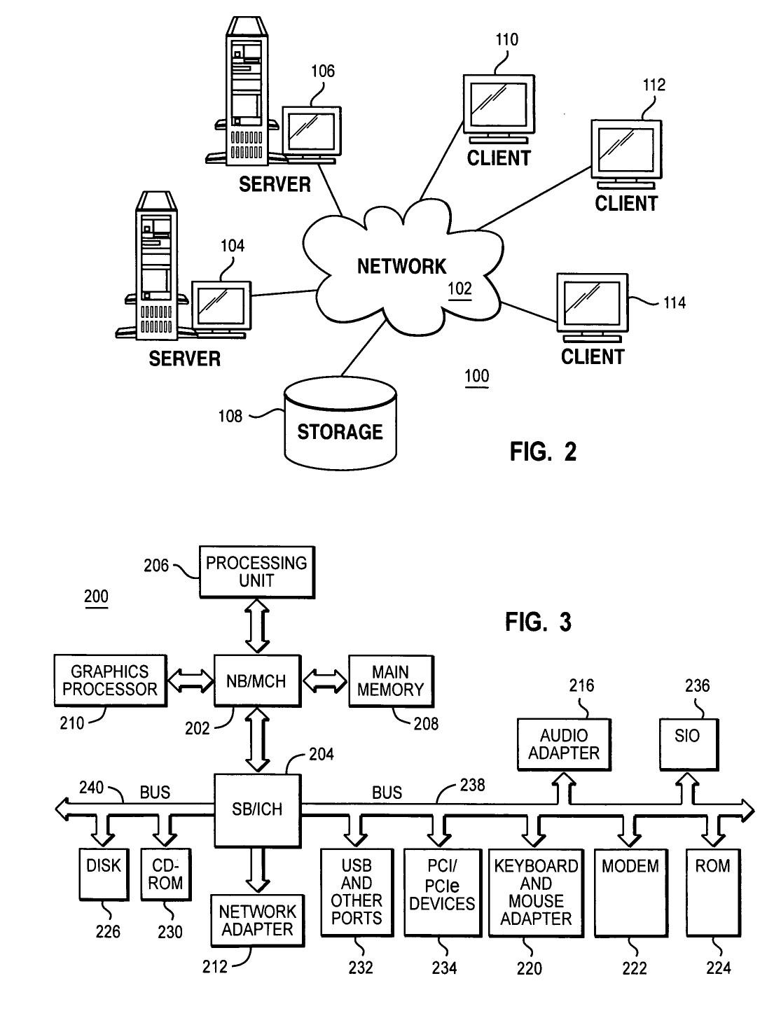

FIGS. 2-3 are provided as exemplary diagrams of data processing environments in which embodiments of the present invention may be implemented. It should be appreciated that FIGS. 2-3 are only exemplary and are not intended to assert or imply any limitations with regard to the environments in which aspects or embodiments of the present invention may be implemented. Many modifications to the depicted environments may be made without departing from the spirit and scope of the present invention. With reference now to FIG. 2, there is shown representation of a network of a data processing system. Network data processing system 100 contains network 102, which is the medium used to provide communications links between various devices and computers connected together within network data processing system 100. Network 102 may include connections, such as wire, wireless communications links, or fiber optic cables.

In the depicted example, server 104 and server 106 connect to network 102 along with storage unit 108. In addition, clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

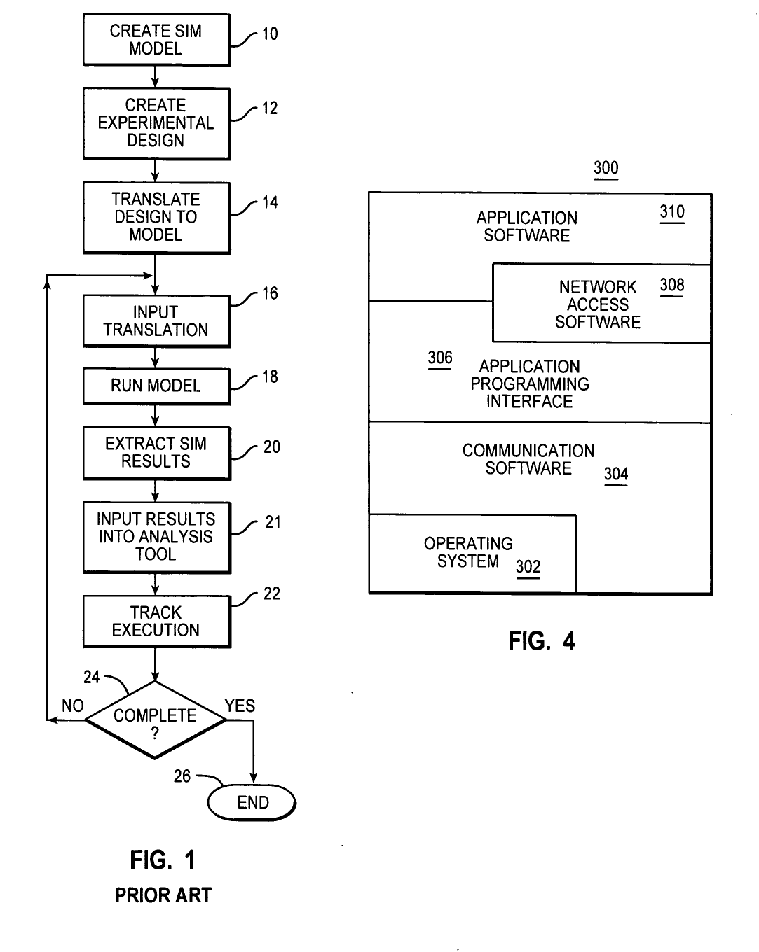

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an Intranet, a local area network (LAN), or a wide area network (WAN). FIG. 1 is intended as an example, and not an architectural limitation for different embodiments of the present invention.

Turning now to the FIG. 3, a block diagram of a data processing system is shown in which aspects of the present invention may be implemented. Data processing system 200 is an example of a computer, such as server 104 or client 110 in FIG. 2, in which computer usable code or instructions implementing the processes for embodiments of the present invention may be located. In the depicted example, data processing system 200 employs a hub architecture including north bridge and memory controller hub (MCH) 202 and south bridge and input/output (I/O) controller hub (ICH) 204. Processing unit 206, main memory 208, and graphics processor 210 are connected to north bridge and memory controller hub 202. Graphic processor 210 may be connected to north bridge and memory controller hub 202 through an accelerated graphics port (AGP).

In the depicted example, LAN adapter 212 connects to south bridge and I/O controller hub 204. Audio adapter 216, keyboard and mouse adapter 220, modem 222, read only memory (ROM) 224, hard disk drive (HDD) 226, CD-ROM drive 230, universal serial bus (USB) ports and other communications ports 232, and PCI/PCIe devices 234 connect to south bridge and I/O controller hub 204 through bus 238 and bus 240. PCI/PCIe devices may include, for example, Ethernet adapters, add-in cards and PC cards for notebook computers. PCI uses a card bus controller, where PCIe does not. ROM 224 may be, for example, a flash binary input/output system (BIOS).

Hard disk drive 226 and CD-ROM drive 230 connect to south bridge and I/O controller hub 204 through bus 240. Hard disk drive 226 and CD-ROM drive 230 may use, for example, an integrated drive electronics (IDE) or serial advanced technology attachment (SATA) interface. Super I/O (SIO) device 236 may be connected to south bridge and I/O controller hub 204.

An operating system runs on processing unit 206 and coordinates and provides control of various components within data processing system 200 in FIG. 3. As a client, the operating system may be a commercially available operating system such as Microsoft® Windows® XP (Microsoft and Windows are trademarks of Microsoft corporation in the United States, other countries, or both). An object-oriented programming system, such as the Java™ programming system, may run in conjunction with the operating system and provides calls to the operating system from Java programs or applications executing on data processing system 200 (Java is a trademark of Sun Microsystems, Inc. in the United States, other countries, or both).

As a server, data processing system 200 may be, for example, an IBM eServer™ pSeries® computer system, running the Advanced Interactive Executive (AIX®) operating system or LINUX operating system (eServer, pSeries and AIX are trademarks of International Business Machines corporation in the United States, other countries, or both while Linux is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as hard disk drive 226, and may be loaded into main memory 208 for execution by processing unit 206. The processes for embodiments of the present invention are performed by processing unit 206 using computer usable program code, which may be located in a memory such as, for example, main memory 208, read only memory 224, or in one or more peripheral devices 226 and 230.

Those of ordinary skill in the art will appreciate that the hardware in FIGS. 2-3 may vary depending on the implementation. Other internal hardware or peripheral devices, such a flash memory, equivalent non-volatile memory, or optical disk drives and the like, may be used in addition to or in place of the hardware depicted in FIGS. 2-3. Also, the processes of the present invention may be applied to the multiprocessor data processing system. In some illustrative examples, data processing system 200 may be a personal digital assistant (PDA), which is configured with flash memory to provide non-volatile memory for storing operating system files and/or user generated data.

A bus system may be comprised of one or more buses, such as bus 238 or bus 240 as shown in FIG. 3. Of course the bus system may be implemented using any type of communications fabric or architecture that provides for a transfer of data between different components or devices attached to the fabric or architecture. A communications unit may include one or more devices used to transmit and receive data, such as modem 222 or network adapter 212 of FIG. 3. A memory may be, for example, a main memory 208, read only memory 224, or a cache such as found in north bridge and memory controller hub 202 in FIG. 3. The depicted examples in FIGS. 2-3 and above-described examples are not meant to imply architectural limitations. For example, data processing system 200 also may be a tablet computer, laptop computer, or telephone device in addition to taking the form of a PDA.

Turning to FIG. 4, typical software architecture for a server-client system is depicted in which exemplary aspects of the present invention may be implemented. At the lowest level, operating system 302 is utilized to provide high-level functionality to the user and to other software. Such an operating system typically includes a basic input/output system (BIOS). Communication software 304 provides communications through an external port to a network such as the Internet via a physical communications link by either directly invoking operating functionality to indirectly bypass the operating system to access the hardware for communications over the network. Application programming interface (API) 306 allows the user of the system, an individual, or a software routine, to invoke system capabilities using a standard consistent interface without concern for how the particular functionality is implemented. Network access software 308 represents any software available for allowing the system to access a network. This access may be to a network, such as a local area network (LAN), wide area network (WAN), or the Internet. With the Internet, this software may include programs, such as Web browsers. Applications software 310 represents any number of software applications designed to react to data through the communications port to provide the desired functionality the user seek, such as an instant messaging application. Applications at this level may include those necessary to handle data, video, graphics, photos or text, which can be accessed by user of the Internet.

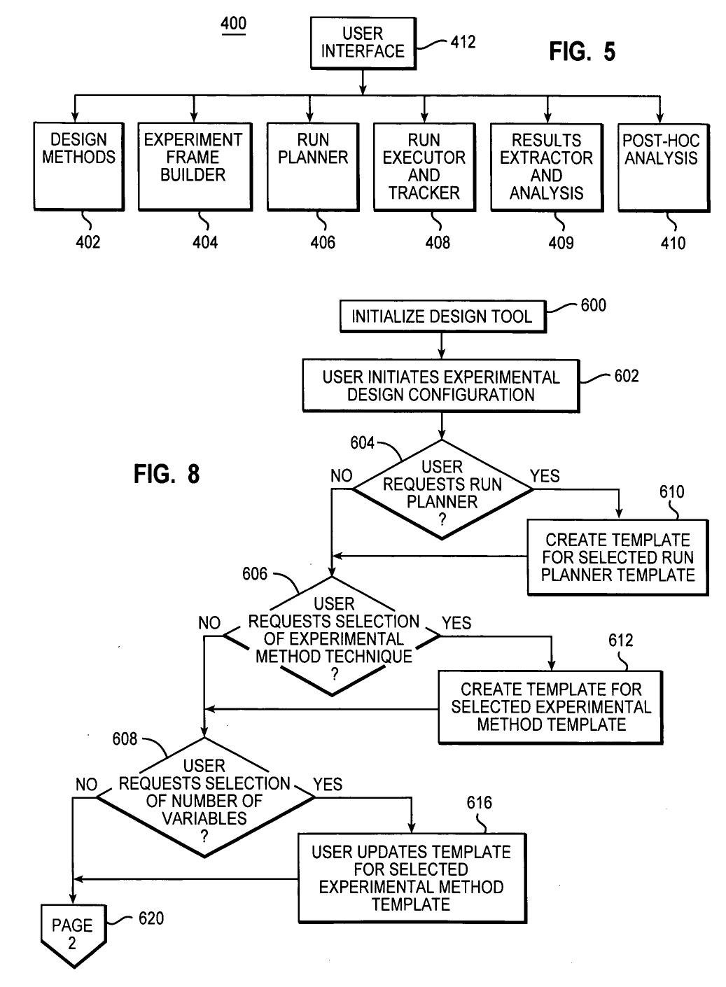

Turning now to FIG. 5, there is shown a block diagram of a Design Tool 400 for automating the design and execution of experimental design based studies. The User Interface 412 includes visual editing tools which allow an analyst to visually assign test subjects to test cells via drag-and-drop procedures which are dynamically rendered on a computer screen, in real-time. Visual assignments of icons are provided, representing the test participants and all attendant and reverent individual characteristic and attributes, such as age and gender. Design methods 402 are included in the Design Tool 400 to allow the inclusion of multiple experimental design techniques such as Latin Square, Fractional Factional, Taguchi, Ad Hoc, Multivariate analysis of variance, canonical correlation, etc. The Experimental Frame Builder 404 includes procedures for creating experimental data tables or tree structures for inputs and outputs within a window. An analyst is allowed to formulate and execute integrated tools/processes with all or part of an experimental design visually and automatically. Run Planner 406 includes entry panels for the simultaneous display of tables and trees of experimental state inputs for easily updating table entry fields. Run Executor and Tracker 408 includes procedures for automatically executing an experiment and saving the results of the experiment for subsequent analysis by an analyst or automated tool. Execution of experiments is tracked visually and tool/process output results are extracted, integrated, and summarized 409. Output results are presented visually in real-time. Finally, Post-Hoc Analysis 410 provides procedures for viewing, evaluating, and adjusting experimental output.

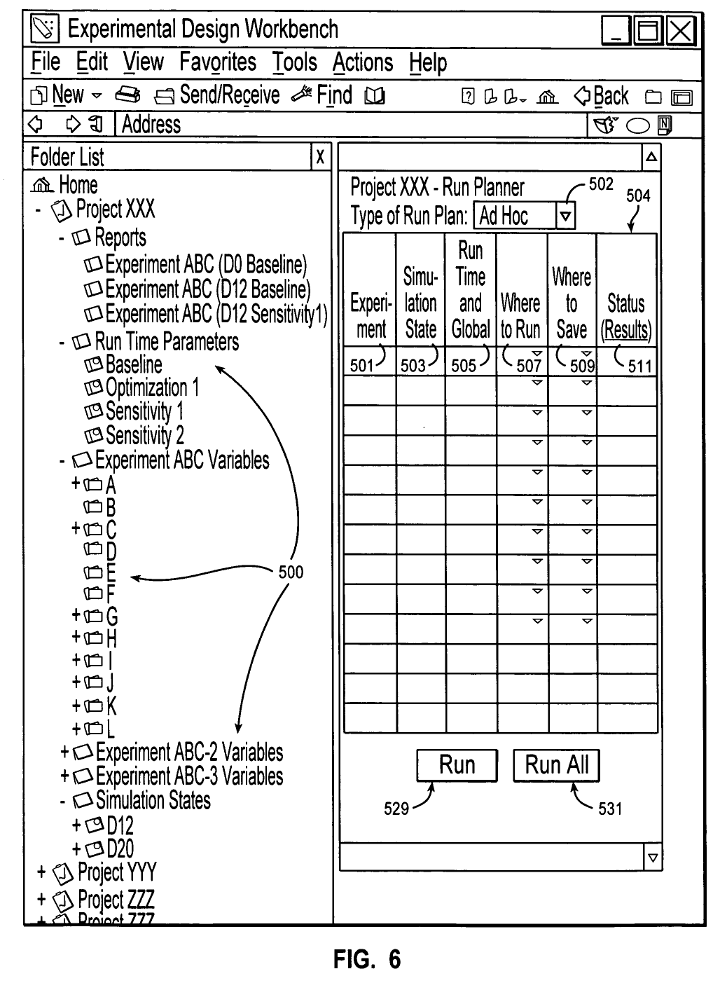

Turning now to FIG. 6, there is shown a graphical window of the Design Tool 400 having a table 504 for input entries for experiments. The table 504 contains a plurality of headers for identifying particular features of an experiment such as Experiment 501, Simulation State 503, Run Time and Global 505, Where to Run 507, Where to Save 509, and Status (Results) 511. The graphical window also contains a tree of experimental state inputs 500 available to the analyst formulating an experiment. Selections from the tree of experimental state inputs 500 may be dragged to and inserted in the table 504. The tree of experimental state inputs 500 contains information related to a particular experiment such as reports, run time parameters, experiment variables, etc. The graphical window also contains a type of run plan 502 field to allow analyst selection of a plurality of statistical experimental techniques. Buttons are provided within the graphical window for executing a single experimental run 529 or all of the experimental runs 531. The disclosed graphical window provides a framework for organizing experimental conditions and submissions factors to minimize the time consuming and error prone procedures required in setting up experimental data sets for statistical analysis.

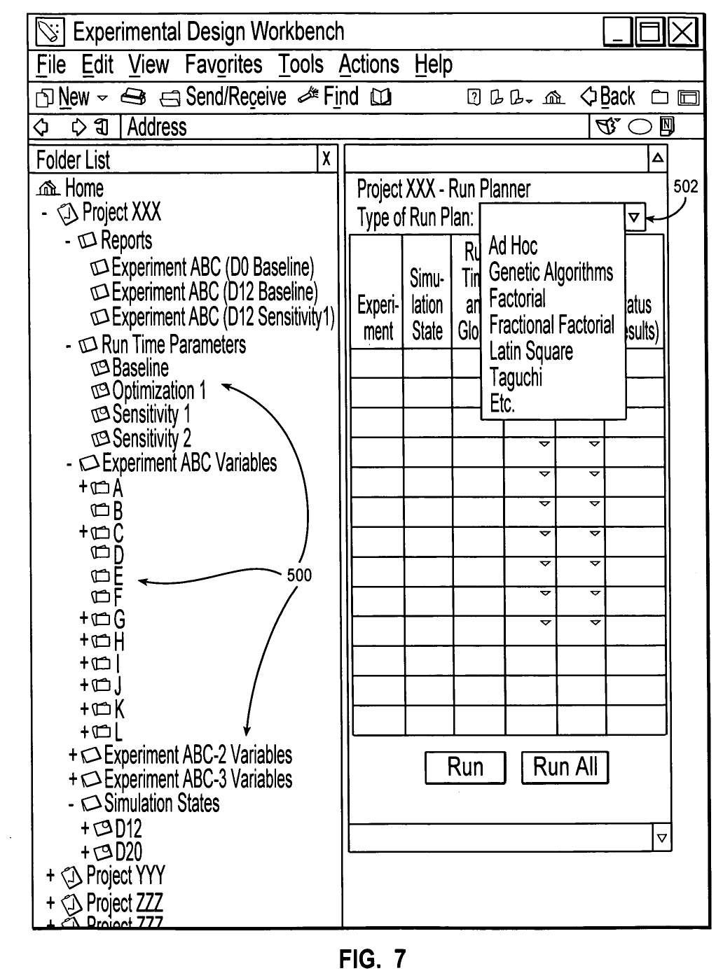

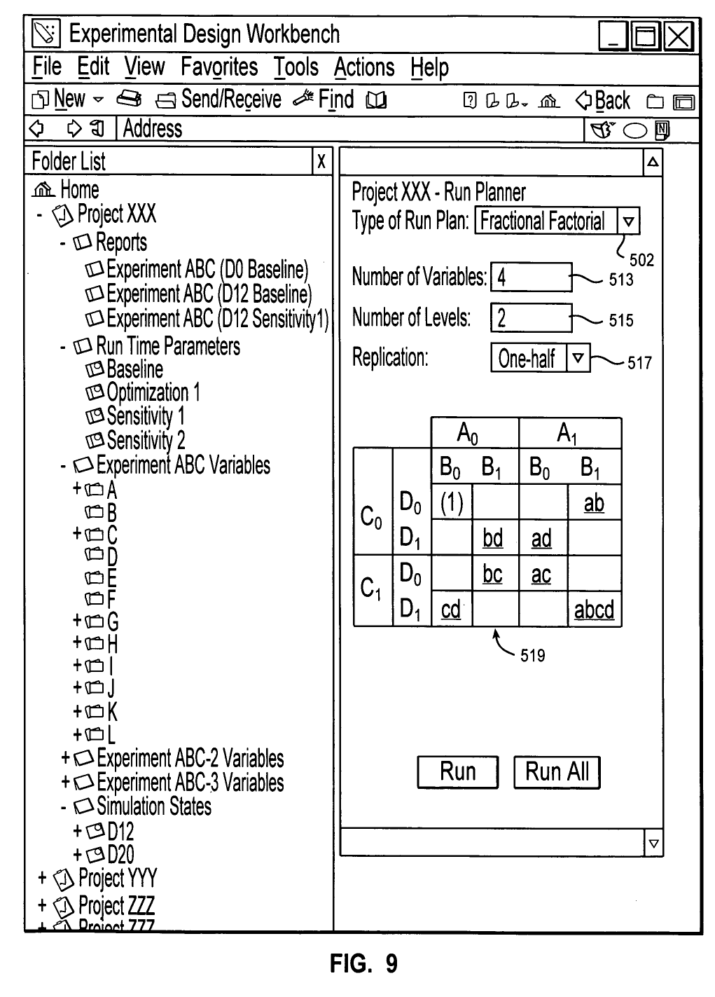

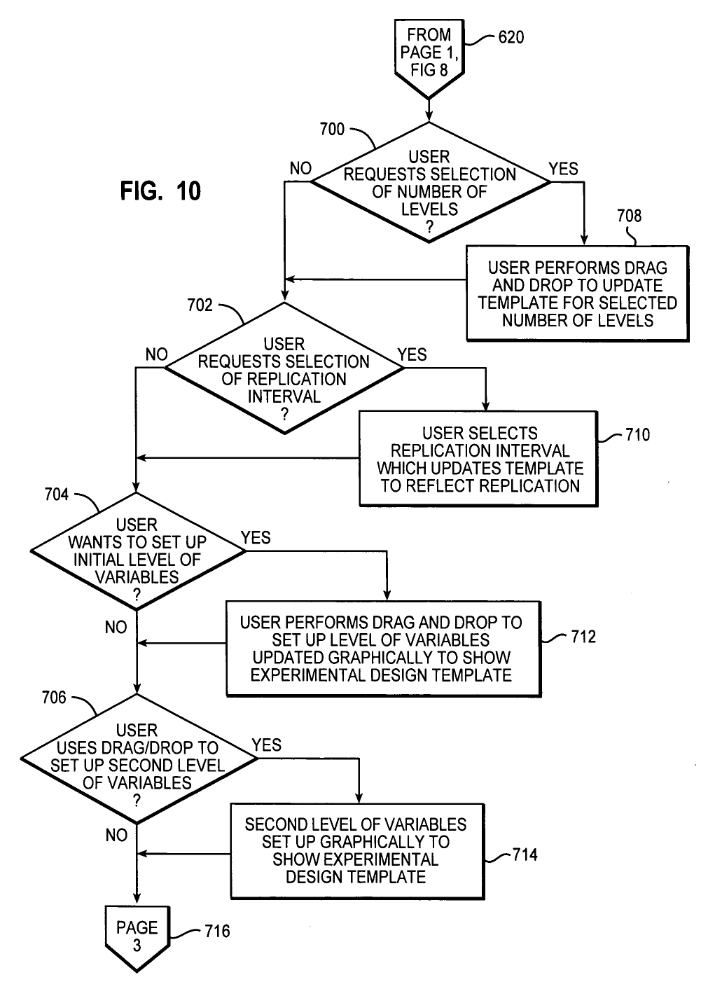

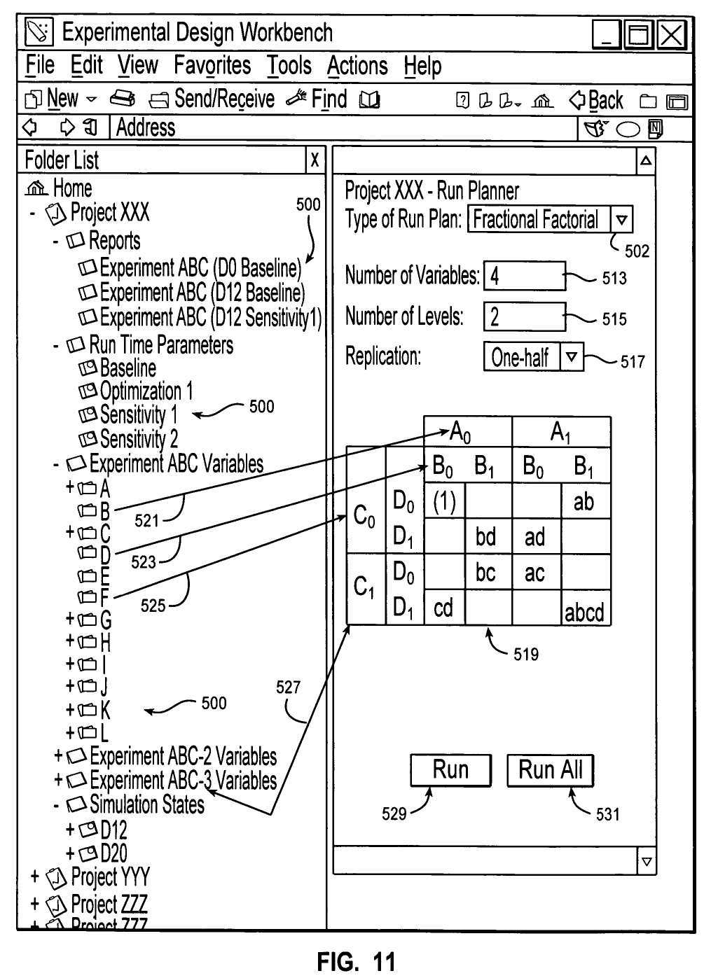

Turning now to FIG. 7, there is shown a Run Planner input window illustrating user selection of a statistical analysis technique using the type of run plan dialog 502. The selection of a particular statistical analysis technique causes the tree of experimental state inputs 500 to be adjusted to reflects the relevant information for that technique. This allows the integration of various experimental techniques so that the selection of a technique adjusts the run planner as needed. An analyst is thus able to visually focus on the experiment and results rather than having to focus on the details of experiment execution. Turning now to FIG. 8, there is shown a flow diagram for adjusting the Run Planner input and information fields shown in FIG. 7. At step 600, the Design Tool is initialized and the User initiates an experimental design configuration 602. At block 604, a determination is made whether the user has requested the Run Planner. If yes, the procedure continues at block 610 with the creation of a template for selecting the Run Planner template. If the user has not requested the Run Planner at block 604, processing proceeds at block 606 where a determination is made whether the user has requested selection of an experimental method technique. The selection dialog for this action is shown in FIG. 7 where multiple experimental method techniques are available from the type of run plan 502 dialog box. Returning to FIG. 8, if the user has selected one of a plurality of experimental method techniques at block 612, creation of a template for the selected experimental method occurs at block 612. If the user has not selected an experimental method technique at block 606, a determination is made at block 608 whether the user has requested selection of the number of variables. The number of variables is specified in the number of variables field 513 in FIG. 9. Returning to FIG. 8, user selection of the number of variables results in the update of the template for the selected experimental method template as shown in block 616. At block 620, processing continues with further updates of the Run Planner input screen table as shown in FIG. 10.

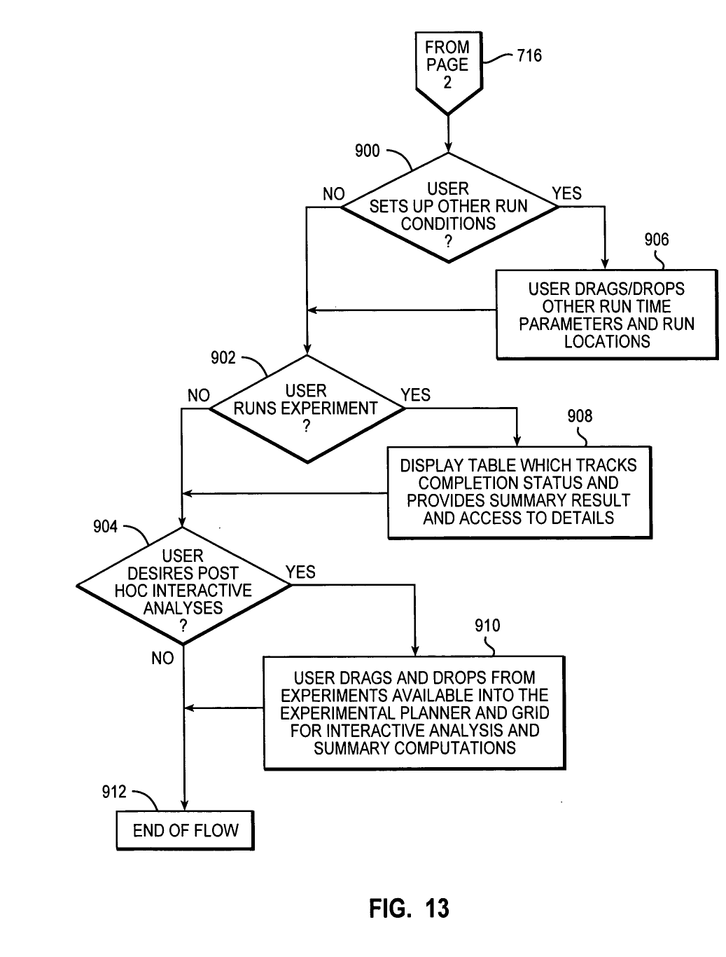

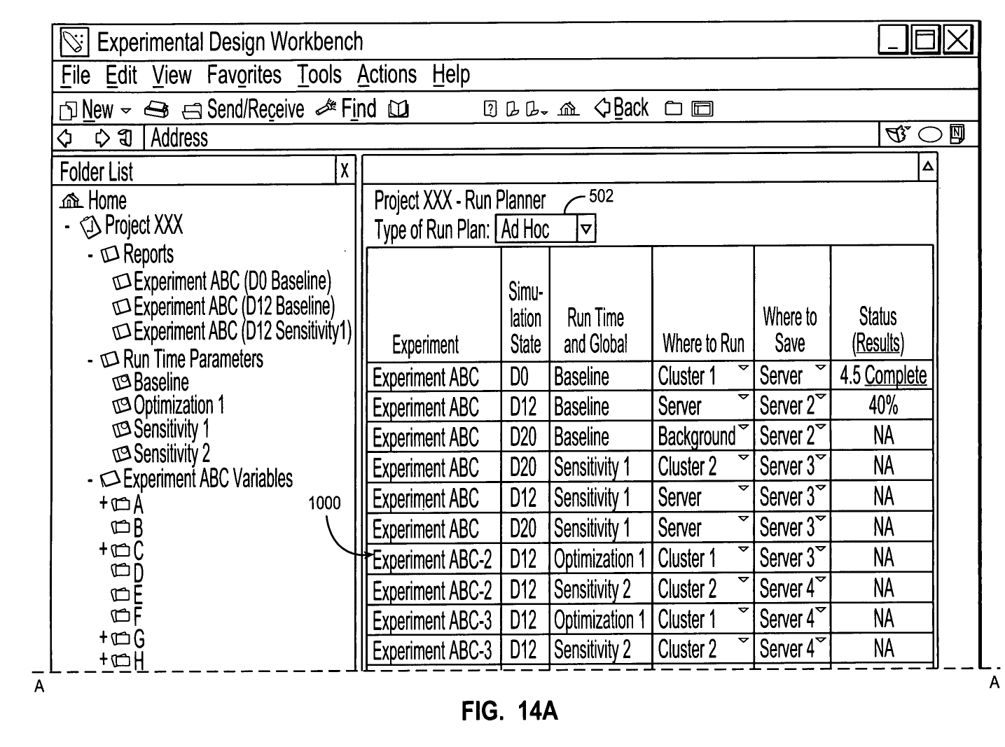

Turning now to FIG. 10, processing continues with a determination at block 700 whether the user has requested selection of the number of levels. If yes, at block 708 the user is allowed to execute drag and drop operations to update the template for selection of the number of levels. FIG. 9 illustrates the number of levels 515 entry field available to the user for requesting the number of levels. Returning to FIG. 10, if the user has not specified the number of levels selection at block 700, the procedure proceeds to block 702 where a determination is made whether the user has requested selection of the replication interval. If yes, at block 710 the user selects the replication interval which updates the template to reflect replication. FIG. 9 shows the replication field 517 where the selection is inputted by the user. Returning to FIG. 10, if the user has not requested selection of a replication interval at block 702, processing proceeds to block 704 where a determination is made whether the user wants to set up initial level of variables. If yes, at block 712 the user performs drag and drop operations to set up level of variables. FIG. 11 more clearly shows the drag and drop operations 521, 523, 525, and 527 performed by the user to update variables in the displayed table 519. The invention allows the user to easily make selections from the tree of experimental state inputs 500 to update entry fields in table 519. The procedure is able to graphically update and show the experimental design template in a more timely and productive manner to minimize or avoid input errors. Returning to FIG. 10, at block 706 a determination is made whether the user is using drag and drop operations to set up the second level of variable as shown in FIG. 11. If yes, at block 714 the procedure provides for setting up the second level of variables graphically to show the experimental design template. The procedure then proceeds to block 716 where additional processing is carried out in FIG. 13.

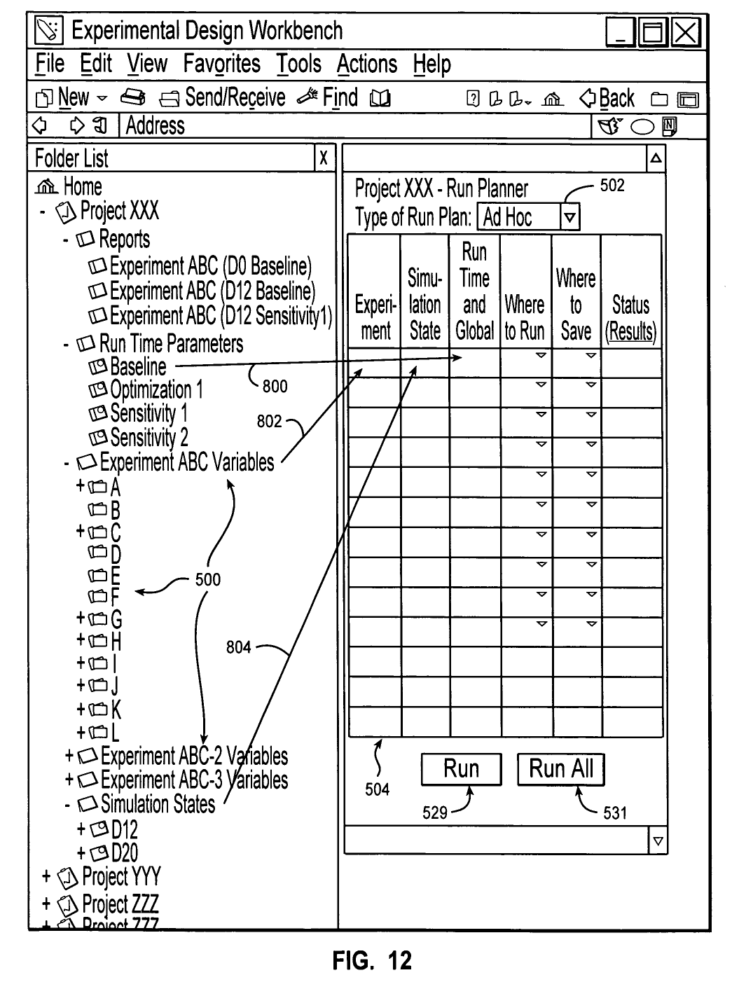

Turning now to FIG. 12, It will be appreciated by those skilled in the art that similar processing apply for each type of experimental technique selected. For example, FIG. 12 illustrates user selection of an Ad Hoc 502 experimental technique using the type of run plan selection dialog. The Run Planner screen is displayed containing table 504 along with the tree of experimental state inputs 500. A user is able to access the tree of experimental state inputs 500 and enter values into table 504 using drag and drop operations 800, 802, and 804. This allows a user to utilize the drag and drop operations to quickly and accurately set up variable and experiment run conditions.

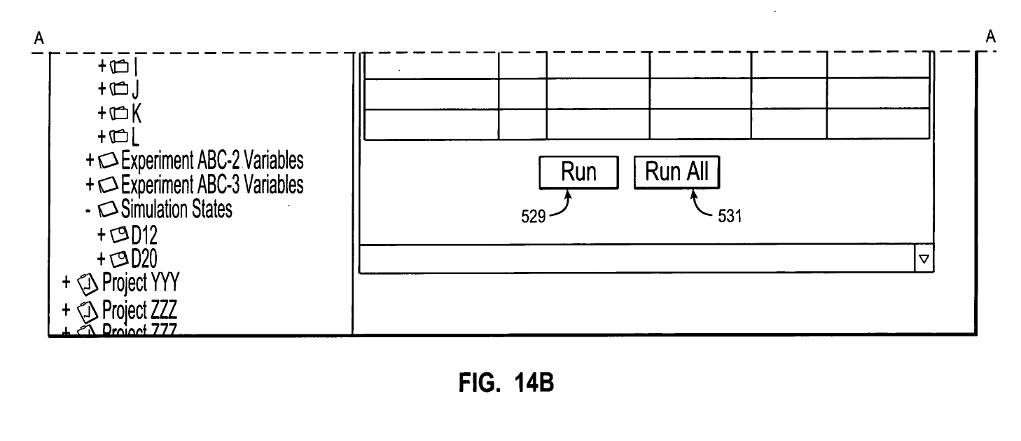

With reference now to FIG. 13, processing continues at block 900 where a determination is made whether the user desires to set up other run conditions. If yes, at block 906 the user drag and drops other run time parameters and run locations. If the user has not selected set up of the run conditions at block 900, processing continues at block 902 where a determination is made whether the user wishes to run an experiment. If yes, at block 908 the experiment is executed and the display table which tracks completion status and provides summary results and access to details is updated and displayed to the user. Turning now to FIG. 14, there is displayed a Run Planner screen having a table 1000. The first experiment in table 1000 is indicating a status of “complete”. The invention permits a user to run a single experiment by selecting run button 529 or all of the experiments using the run all button 531. The table 1000 contains the input information along with the status of all the experiments in a single graphical table.

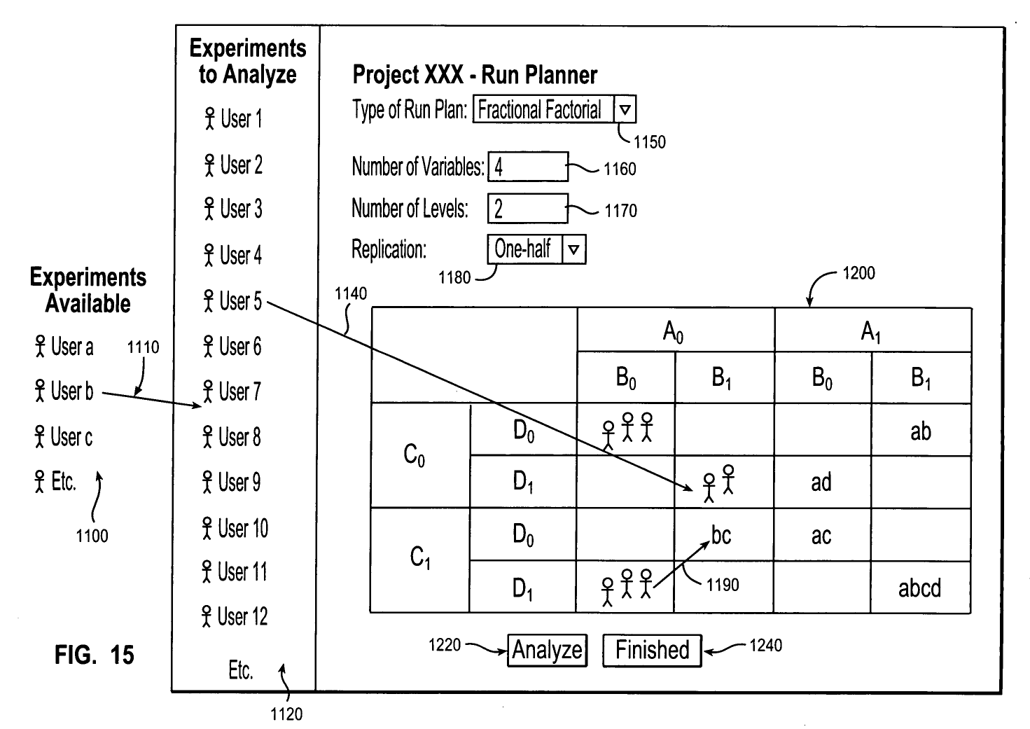

Turning now to FIG. 15, there is shown an embodiment of the invention for Post Hoc analysis of experimental information integrated from the Run Planner or other data sources. The Run Planner is used to execute results and provides quick access to detailed data. The Analyzer allows the runs associated with a set of experiments to be manipulated in order to obtain the best experimental results. As appreciated by those skilled in the art, data from other sources may also be plugged into the Analyzer. FIG. 15 illustrates interactive analysis of experiments using a combination of direct entry and drag-drop operations to enter experimental information into a grid 1200. The available experiments 1100 are displayed to the user. The user places the desired experiments into a queue of experiments to be analyzed 1120 using drag-drop operations 1110. The user carries out the interactive analysis using grid 1200 by inserting information into the grid 1200 using drag-drop operations 1140/1190 or by direct entry of input information. The type of run plan 1150, number of variables 1160, number of levels 1170, and replication 1180 for the grid are specified by the user for the interactive analysis. Once the user is satisfied with the entry of experimental information into the grid 1200, selection of the analyze button 1220 causes the experiment to be analyzed. One skilled in the art will appreciate that any number of experimental variations may be interactively executed using the invention. Once the user is satisfied that experimental analysis is completed, selection of the finished button 1240 causes the output of the experiment to be saved or discarded.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

It will be apparent to those skilled in the art having the benefit of this disclosure that the present invention contemplates methods, systems, and media for sharing input device movement information in an instant messaging system. It is understood that the form of the invention shown and described in the detailed description and the drawings are to be taken merely as examples. It is intended that the following claims be interpreted broadly to embrace all the variations of the example embodiments disclosed.

What is claimed is:

1. A method for specifying experimental design information by a user in a data processing computer system, the method comprising:
creating a collection of structured experimental state inputs having experimental design information in a graphical window of a display in said data processing computer system;
creating a configurable table having entries for selected ones of said collection of structured experimental state inputs wherein said table is simultaneously displayed with said collection of structured experimental state inputs; and
selecting at least one of said collection of structured experimental state inputs to modify said configurable table.

2. The method of claim 1, wherein the creation of a configurable table comprises selecting one of a plurality of experimental techniques by said user.

3. The method of claim 2, wherein the creation of a configurable table comprises creating a template for said selected one of said plurality of experimental techniques by said user.

4. The method of claim 1, wherein selecting at least one of said collection of structured experimental state inputs comprises dragging and dropping said selected input to an entry position in said configurable table.

5. The method of claim 1, wherein selecting at least one of said collection of structured experimental state inputs comprises displaying said modification of said configurable table to said user.

6. The method of claim 1, wherein creating a configurable table having entries:
providing a table having entries for experimental information for a user selected experimental techniques; and
dragging and dropping information from said collection of structured experimental inputs to provide set up information for said table.

7. The method of claim 1, wherein said user selects one of a plurality of experiments to be executed from said configurable table.

8. The method of claim 1, wherein an output is produced from executing one of said plurality of experiments in said configurable table and displaying said output in said table.

9. A machine-accessible medium containing instructions effective, when executing in a data processing system, to cause said data processing system to perform operations for specifying experimental design information by a user comprising:
creating a collection of structured experimental state inputs having experimental design information in a graphical window of a display in said data processing computer system;
creating a configurable table having entries for selected ones of said experimental state inputs simultaneously displayed with said collection of structured experimental state inputs; and
selecting at least one of said collection of structured experimental state inputs to modify said configurable table.

10. The machine-accessible medium of claim 9, wherein the creation of a configurable table comprises selecting one of a plurality of experimental techniques by said user.

11. The machine-accessible medium of claim 10, wherein the creation of a configurable table comprises creating a template for said selected one of said plurality of experimental techniques by said user.

12. The machine-accessible medium of claim 9, wherein selecting at least one of said collection of structured experimental state inputs comprises dragging and dropping said selected input to an entry position in said configurable table.

13. The machine-accessible medium of claim 9, wherein selecting at least one of said collection of structured experimental state inputs comprises displaying said modification of said configurable table to said user.

14. The machine-accessible medium of claim 9, wherein creating a configurable table having entries comprises:
providing a table having entries for experimental information for a user selected experimental techniques; and
dragging and dropping information from said collection of structured experimental inputs to provide set up information for said table.

15. The machine-accessible medium of claim 9, wherein said user selects one of a plurality of experiments to be executed from said configurable table character.

16. The machine-accessible medium of claim 9, wherein an output is produced from executing one of said plurality of experiments in said configurable table and displaying said output in said table.

17. A data processing computer system for specifying experimental design information by a user in said data processing computer system comprising:
means for creating a collection of structured experimental state inputs having experimental design information in a graphical window of a display in said data processing computer system;
means for creating a configurable table having entries for selected ones of said collection of structured experimental state inputs wherein said table is simultaneously displayed with said collection of structured experimental state inputs; and
means for selecting at least one of said collection of structured experimental state inputs to modify said configurable table.

18. The system of claim 17, wherein the means for creation of a configurable table comprises means for selecting one of a plurality of experimental techniques by said user.

19. The system of claim 18, wherein the means for creating a configurable table comprises means for creating a template for said selected one of said plurality of experimental techniques by said user.

20. The system of claim 17, wherein the means for selecting at least one of said collection of structured experimental state inputs comprises means for dragging and dropping said selected input to an entry position in said configurable table.

21. The system of claim 17, wherein the means for selecting at least one of said collection of structured experimental state inputs comprises means for displaying said modification of said configurable table to said user.

22. The system of claim 17, wherein the means for creating a configurable table having entries comprises:
means for providing a table having entries for experimental information for a user selected experimental techniques; and
means for dragging and dropping information from said collection of structured experimental inputs to set up information for said table.

23. The system of claim 17, wherein a user selects one of a plurality of experiments to be executed from said configurable table.

24. A method for analyzing experimental design output by a user in a data processing computer system, the method comprising:
providing a plurality of experimental outputs resulting from runs of experimental design information in a graphical window of a display in said data processing computer system;
creating a configurable table having entries for selected ones of said plurality of experimental outputs wherein said table is simultaneously displayed with said plurality of experimental outputs; and
initiating the analysis of said experimental outputs for selected ones of said plurality of experimental outputs within said configurable table.

25. The method of claim 24, wherein the step of creating a configurable table includes dragging and dropping experimental outputs from said plurality of experimental outputs to user selected entries in said table.

26. A machine-accessible medium containing instructions effective, when executing in a data processing system, to cause said data processing system to perform operations for analyzing experimental design output by a user comprising:
providing a plurality of experimental outputs resulting from runs of experimental design information in a graphical window of a display in said data processing computer system;
creating a configurable table having entries for selected ones of said plurality of experimental outputs wherein said table is simultaneously displayed with said plurality of experimental outputs; and
initiating the analysis of said experimental outputs for selected ones of said plurality of experimental outputs within said configurable table.

27. The machine-accessible medium of claim 26, wherein the step of creating a configurable table includes dragging and dropping experimental outputs from said plurality of experimental outputs to user selected entries in said table.
